(19) United States
(12) Patent Application Publication
(10) Pub. No.: US 2025/0184025 A1
(43) Pub. Date: Jun. 5, 2025

(54) SYSTEM AND METHOD TO DISCOVER CANDIDATE PTP CLOCK SOURCE(S) OVER IP/MPLS NETWORK

(71) Applicant: CIENA CORPORATION, Hanover, MD (US)

(72) Inventors: Sharad Kumar Srivastava, Varanasi (IN); Vineet Kumar Garg, Gurgaon (IN); Krishan Singh, Haryana (IN); Vijendra Singh Chauhan, Indore (IN)

(73) Assignee: CIENA CORPORATION, Hanover, MD (US)

(21) Appl. No.: 19/041,610

(22) Filed: Jan. 30, 2025

Related U.S. Application Data
(63) Continuation-in-part of application No. 18/419,810, filed on Jan. 23, 2024.

(30) Foreign Application Priority Data
Nov. 30, 2023 (IN) 202311081663
Dec. 17, 2024 (IN) 202411099932

(51) Int. Cl. H04J 3/06; H04L 45/02; H04L 45/50

(52) U.S. Cl. CPC H04J 3/0667; H04L 45/04; H04L 45/50

(57) ABSTRACT

Aspects of the subject disclosure may include, for example, a device, including: a processing system including a processor; a clock; and a memory that stores executable instructions that, when executed by the processing system, facilitate performance of operations of: advertising via Border Gateway Protocol (BGP) a capability as a precision timing protocol (PTP) master clock through an Internet Protocol (IP)/Multi-Protocol Label Switching (MPLS) network, wherein the advertising includes an IP address of the device; receiving a unicast signaling mechanism from a PTP client node in the network; and sending clock messages to the PTP client node responsive to accepting the PTP client node. Other embodiments are disclosed.

### CROSS-REFERENCE TO RELATED APPLICATION(S)

This application claims priority to Indian Patent Application number 202411099932, filed on Dec. 17, 2024. This application is also a Continuation-In-Part of U.S. patent application Ser. No. 18/419,810, filed on Jan. 23, 2024, which claims priority to Indian Patent Application number 202311081663, filed on Nov. 30, 2023. All sections of the aforementioned application(s) and/or patent(s) are incorporated by reference herein in their entirety.

### FIELD OF THE DISCLOSURE

The subject disclosure relates to a system and method to discover candidate precision timing protocol (PTP) master clock sources over an Internet Protocol (IP)/multi-protocol label switching (MPLS) network.

### BACKGROUND

PTP has become critical to deliver synchronization of radios in modern cellular networks, such as fifth generation (5G) networks. 5G networks have been rapidly evolving into a fully automated network. Today a network administrator needs to manually provision an IP address for a candidate master clock to enable PTP synchronization of node over IP. Furthermore, the administrator must manually provision such IP address(es) whenever a list of potential master clock changes.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of precision time protocol nodes in a network in accordance with various aspects described herein.

FIG. 2A is a block diagram illustrating an exemplary, non-limiting embodiment of precision time protocol nodes in an OSPF network in accordance with various aspects described herein.

FIG. 2B is a block diagram illustrating an exemplary, non-limiting embodiment of advertising precision time protocol capability by nodes in an IP/MPLS network via interior BGP (iBGP) in accordance with various aspects described herein.

FIG. 2C is a block diagram illustrating an exemplary, non-limiting embodiment of advertising precision time protocol capability by nodes in an IP/MPLS network via exterior and interior BGP in accordance with various aspects described herein.

FIG. 2D is a block diagram illustrating an exemplary, non-limiting embodiment of advertising precision time protocol capability by nodes in an IP/MPLS network via exterior and interior BGP in accordance with various aspects described herein.

FIG. 3 depicts an illustrative embodiment of a method performed by a node in an IP network in accordance with various aspects described herein.

FIG. 4 is a block diagram of an example, non-limiting embodiment of a computing environment in accordance with various aspects described herein.

### DETAILED DESCRIPTION

The subject disclosure describes, among other things, illustrative embodiments for a precision time protocol master clock advertising its capabilities over Internet Protocol networks. Other embodiments are described in the subject disclosure.

One or more aspects of the subject disclosure include a device, including: a processing system including a processor; a clock; and a memory that stores executable instructions that, when executed by the processing system, facilitate performance of operations of: advertising via Border Gateway Protocol (BGP) a capability as a precision timing protocol (PTP) master clock through an Internet Protocol (IP)/Multi-Protocol Label Switching (MPLS) network, wherein the advertising includes an IP address of the device; receiving a unicast signaling mechanism from a PTP client node in the network; and sending clock messages to the PTP client node responsive to accepting the PTP client node.

One or more aspects of the subject disclosure include a method of receiving, by a precision timing protocol (PTP) client node in an Internet Protocol (IP)/Multi-Protocol Label Switching (MPLS) network, a Border Gateway Protocol (BGP) message indicating a master clock capability of a PTP master clock node; sending, by the PTP client node, a unicast signaling request to the PTP master clock node to register as a PTP client; and receiving, by the PTP client node, clock messages from the PTP master clock node responsive to the unicast signaling request.

One or more aspects of the subject disclosure include a non-transitory, machine-readable medium, storing executable instructions that, when executed by a processing system including a processor, facilitate performance of operations, including: identifying a first precision timing protocol (PTP) master clock from a Border Gateway Protocol (BGP) message received over an Internet Protocol (IP)/Multi-Protocol Label Switching (MPLS) network; registering as a first PTP client node with the first PTP master clock; synchronizing a clock with first clock messages received from the first PTP master clock; advertising a capability as a second PTP master clock through the IP/MPLS network; receiving a request from a second node in the IP/MPLS network to become a second PTP client node; and sending second clock messages to the second PTP client node responsive to accepting the second PTP client node.

ITU-T has defined two telecommunications standards, namely G.8265.1 and G.8275.2, for the frequency recovery and phase recovery, respectively, in IP networks. These standards propose a unicast discovery option defined by IEEE 1588 (sec 16.1) to allow a PTP client to contact a master clock in a network that does not offer multicasting. The PTP client uses unicast negotiations to discover the best master available over an IP network. This mechanism requires a manual configuration of the client node with the IP addresses of all the available master clocks. Once the master clock IP address is configured on the PTP client node, the PTP client node starts unicast negotiations by sending signaling request messages for announce, sync and delay information provided by the PTP master clock.

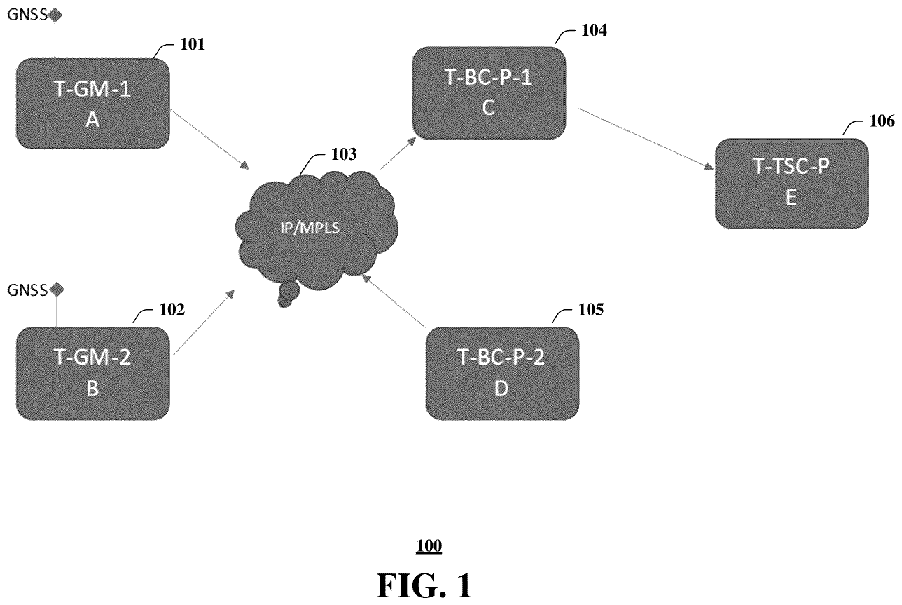

FIG. 1 is a block diagram illustrating an exemplary, non-limiting embodiment of precision time protocol nodes in a network in accordance with various aspects described herein. As shown in FIG. 1, network 100 includes two master clock nodes 101, 102, an IP/MPLS cloud 103, two boundary clock nodes 104, 105 and a client node 106. Master clock nodes 101 and 102 synchronize their clocks using time information from a time source, such as a Global Navigation Satellite Service (GNSS) receiver. Normally, a system administrator would have to provision nodes 104 and 105 as PTP client nodes having IP address of nodes 101 and 102 as candidate master clocks. Furthermore, nodes 104 and 105 would also be provisioned as having master clock functionality. Finally, node 106 would be provisioned as a client node having the IP address of node 104 as a candidate master clock.

In an embodiment, an administrator would not have to provision nodes 104, 105 and 106 with IP addresses of candidate master clock nodes. Instead, nodes 104, 105 and 106 would learn which hosts (e.g., nodes 101, 102, 104 and 105) have an advertised PTP master capability. Based on this information, client nodes can start a PTP unicast signaling mechanism over IP/MPLS cloud 103 to master clock nodes at the IP addresses advertised. In an embodiment, a node that has advertised this capability using Interior Gateway Protocol (IGP) would receive a unicast signaling request and can decide whether to grant the request for service or not in the usual fashion. Based on the signaling mechanism, client nodes can start getting announcement messages from potential master clock nodes and then decide which is the best master clock based on IEEE-1588/profile specific state machine and the Best Master Clock Algorithm (BMCA).

In an embodiment, the system sends the announcement messages using Intermediate System to Intermediate System (ISIS) or Open Shortest Path First (OSPF) via IGP. In a case where some of the candidate master clock nodes are not within an ISIS or OSPF area of reachability, an administrator can manually configure the IP address as usual. However, it is also important to note that for telecom applications based on G.8275.2 recommended clocking architectures, candidate master clocks are generally within few IP hops from client nodes and thereby very likely to be within same ISIS or OSPF domain as the client nodes. For OSPF, a router can send PTP master clock capabilities via router information in an opaque Link State Advertisement (LSA).

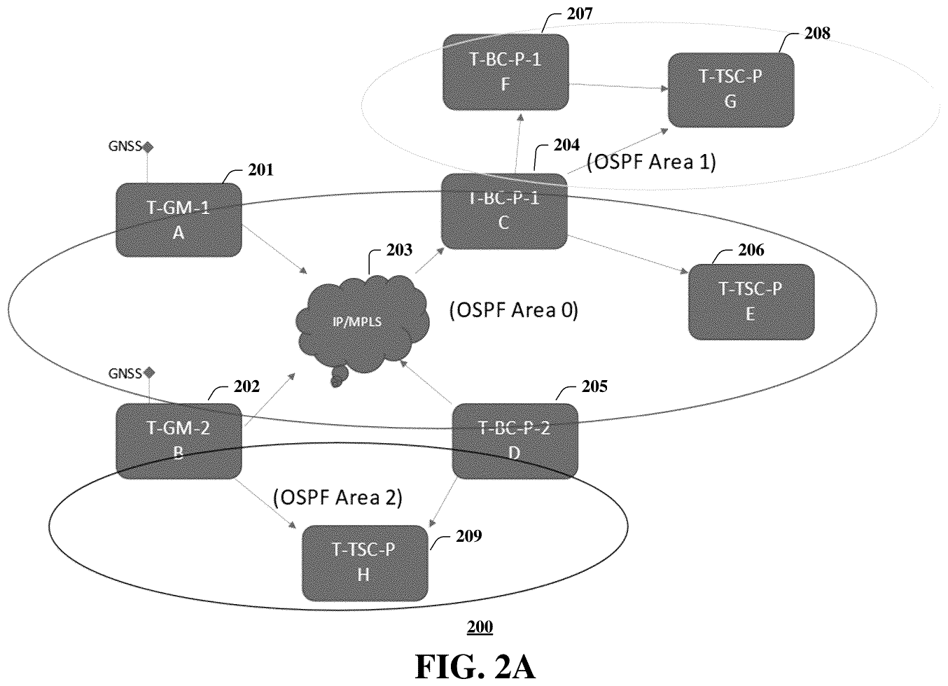

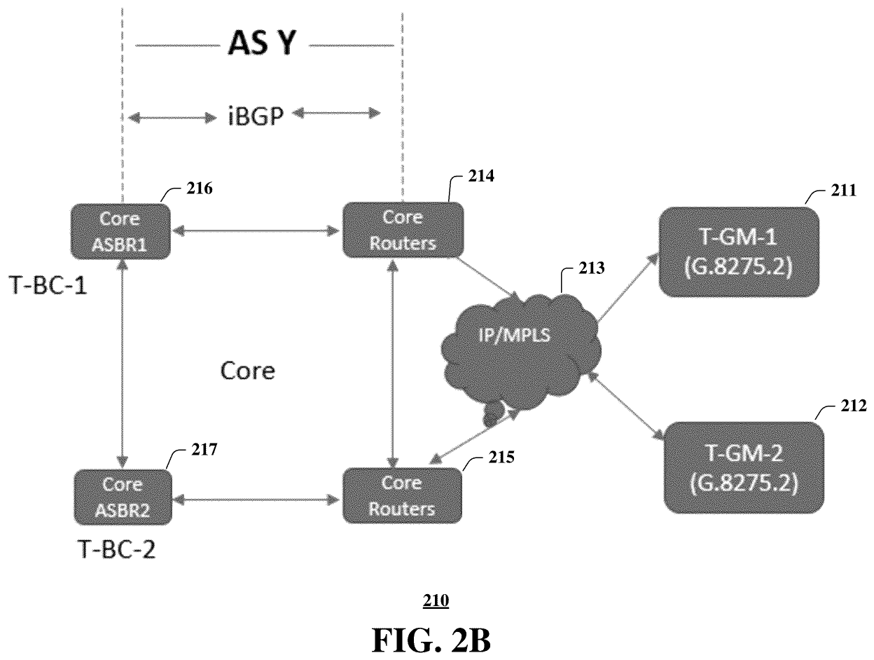

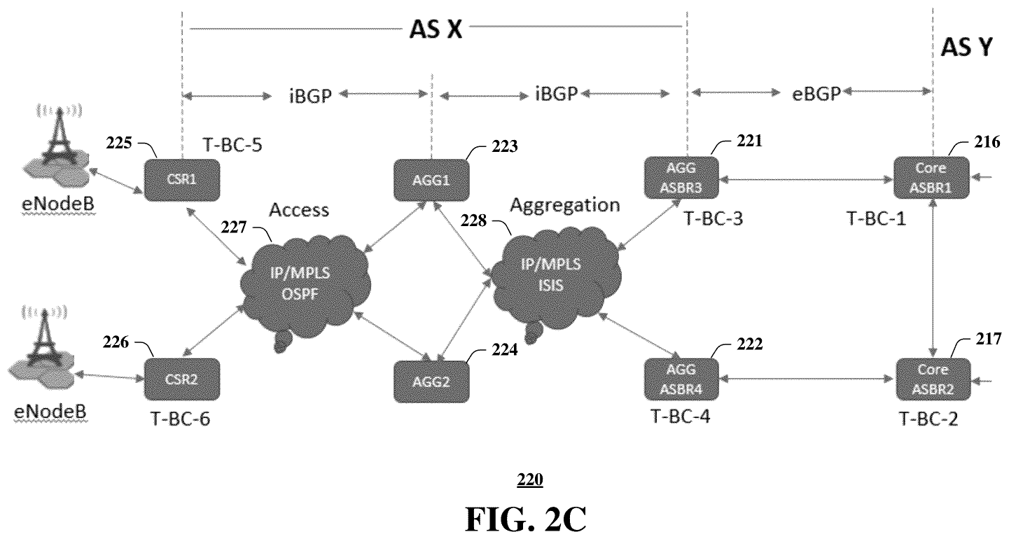

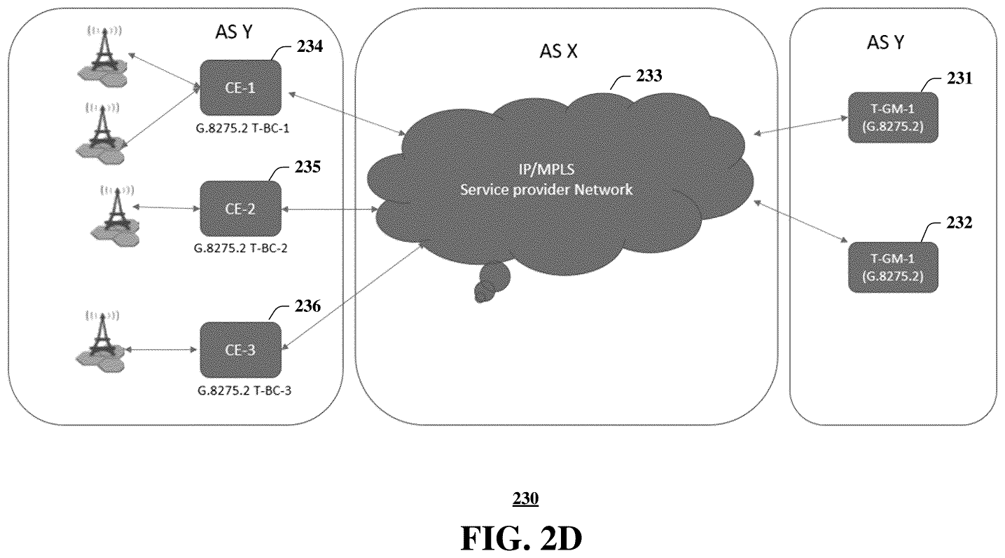

FIG. 2A is a block diagram illustrating an exemplary, non-limiting embodiment of precision time protocol nodes in an OSPF network in accordance with various aspects described herein. As shown in FIG. 2A, network 200 includes two master clock nodes 201, 202, an IP/MPLS cloud 203, two boundary clock nodes 204, 205 and client nodes 206, 207, 208 and 209. Nodes 201, 202, 204, 205 and 206 are withing OSPF Area 0. Nodes 204, 207 and 208 are within OSPF Area 1, and nodes 202, 205 and 209 are within OSPF Area 2. In an embodiment, OSPF propagation for PTP capability will be limited within an OSPF area and will not be flooded in other areas. In case of clocking networks spanning across many OSPF areas, area border routers (ABRs) can act as boundary clocks, such that they can lock to candidate master clock nodes in one area and also advertise themselves as master clock nodes for adjacent areas that they serve.

For example, master clock nodes 201 and 202 are both advertised as candidate PTP master clock nodes in Area 0 but not advertised in OSPF Area 1. However, node 204, which is an ABR between Area 0 and Area 1, will recognize nodes 201 and 202 as candidate master clock nodes through OSPF. Similarly, node 204 can advertise itself as a candidate master clock in Area 1, so that PTP client nodes like nodes 207 and 208 can lock onto it. As per PTP protocol, node 204 will advertise a holdover (or free run as the case may be) clock class to its clients in area 1 until node 204 is locked to a master clock in Area 0.

Each ABR working as boundary clock can propagate clock information by advertising itself as candidate master in downstream OSPF areas. This process prevents clock synchronization capability from flooding across OSPF areas. However, an administrator can still manually configure a client with an IP address of a master clock node outside of its own area without taking advantage of the mechanism proposed here.

In another embodiment, ISIS can advertise a new link state protocol (LSP) data unit (sub-TLV) in the following format for loopback IP interfaces:
IP interface PTP master role flag
Type: (new type)
Length: 1
Value: 0 or 1 (PTP Master Role advertisement flag False/True)

In an ISIS-based IGP domain, a PTP master clock would advertise its capability via sub-TLV contained in the sub-TLV of ISIS IP reachability extensions. This capability can be limited to being intra-level to ISIS levels and an ISIS L1/L2 router can be a boundary block if clock has to traverse multiple ISIS levels. This is similar to the proposal detailed above for OSPF case.

FIG. 2B is a block diagram illustrating an exemplary, non-limiting embodiment of advertising precision time protocol capability by nodes in an IP/MPLS network via interior BGP (iBGP) in accordance with various aspects described herein. As shown in FIG. 2B, network 210 includes two master clock nodes 211, 212, an IP/MPLS cloud 213, two core routers 214, 215 and two autonomous system border routers (ASBR 216 and ASBR 217) in an autonomous system (AS Y). ASBR 216 and ASBR 217 are not configured with an IP address of a candidate PTP master clock. Instead, they use BGP information to find which/32 hosts that are reachable and have advertised PTP master capability. Based on this information, ASBR 216 and ASBR 217 as client nodes may employ a unicast signaling mechanism directed to the IP address(es) of the advertised PTP master clock nodes. ASBR 216 or ASBR 217 can use a BGP attribute, such as AS Path, to determine if the PTP master clock capable node is in same AS (or in a different AS). The client can use this information to filter out master clock candidates. If a node that has advertised master clock capability via iBGP receives a unicast signaling request, the node can decide whether to grant the request for service or not. Based on the unicast signaling mechanism, client nodes can start getting announce messages from potential masters and then decide best master based on IEEE-1588/profile specific state machine and BMCA.

For instance, master clock node 211 has advertised PTP master capability on prefix X.X.X.X/32. Node 211 can attach a PTP master clock capability path attribute (optional Transitive) to prefix NLRI X.X.X.X/32 and send the attribute to peers over iBGP update. Next, ASBR 216 and ASBR 217 receive this iBGP update and thus learn that node 211 has PTP master clock capability on prefix X.X.X.X/32. Then ASBR 216 and ASBR 217 can start a unicast session request with node 211 as specified in ITU-T G.8275.2 recommendations.

FIG. 2C is a block diagram illustrating an exemplary, non-limiting embodiment of advertising precision time protocol capability by nodes in an IP/MPLS network via exterior and interior BGP in accordance with various aspects described herein. As shown in FIG. 2C, network 220 includes a first autonomous system (AS Y) that includes two autonomous system border routers (ASBR 216 and ASBR 217), and a second autonomous system (AS X) including six nodes comprising two autonomous system border routers (ASBR 221 and ASBR 222), two aggregating nodes AGG1 223 and AGG2 224, two cell site router nodes CSR1 225 and CSR2 226, and two IP/MPLS networks 227, 228 joining the six nodes together.

ASBR 221 and ASBR 222 as well as CSR1 225 and CSR2 226 are not configured with an IP address of a candidate PTP master clock. Instead, they use BGP information to find which/32 hosts that are reachable and have advertised PTP master capability. ASBR 216 and ASBR 217 in the first autonomous system AS Y happen to have master clock capability and can advertise this capability via external BGP (eBGP) update to ASBR 221 and ASBR 222. In turn, ASBR 221 and ASBR 222 also have master clock capability and advertise this capability via iBGP in a fashion set forth above in connection with FIG. 2A to nodes CSR1 225 and CSR2 226 that are downstream of the master clock node.

FIG. 2D is a block diagram illustrating an exemplary, non-limiting embodiment of advertising precision time protocol capability by nodes in an IP/MPLS network via exterior and interior BGP in accordance with various aspects described herein. System 230 comprises a first autonomous system AS Y connected together by a second autonomous system AS X comprising a service provider network 233. Two nodes in AS Y, T-GM-1 231 and T-GM-2 232 serve as master clock nodes within AS Y. T-GM-1 231 and T-GM-2 232 advertise PTP master clock capability via eBGP over service provider network 233. T-GM-1 231 and T-GM-2 232 synchronize their clocks using time information from a time source, such as a Global Navigation Satellite Service (GNSS) receiver.

Service provider network 233 is a third-party MPLS timing unaware network that facilitates communication between various nodes in system 230. Service provider network 233 enables the transmission of eBGP advertisements and clock messages between primary clock nodes and client nodes. T-GM-1 231 and T-GM-2 232 are reachable over service provider network 233. T-GM-1 and T-GM-2 can advertise their master clock capability to directly connected PE routers in third-party MPLS network. These PE routers can carry VPNv4/VPNv6 BGP routes over service provider network 233 to PE routers connected to CEs. PE routers that are connected to CEs can use eBGP to advertise T-GM-1 231 and T-GM-2 232 routes. T-GM-1 231 and T-GM-2 232 send clock messages to client nodes that register as PTP clients based on the advertised capability. Service provider network 233 ensures that the PTP primary clock capabilities are propagated to the relevant nodes within the network.

The first autonomous system AS Y also comprises three nodes CE-1 234, CE-2 235 and CE-3 236 that operate as a boundary clock nodes within the network. CE-1 234, CE-2 235 and CE-3 236 receive PTP clock advertisements from the T-GM-1 231 and T-GM-2 232. CE-1 234, CE-2 235 and CE-3 236 nodes can initiate unicast sessions with T-GM-1 231 and T-GM-2 232. CE-1 234, CE-2 235 and CE-3 236 can also advertise their own PTP master clock capability to nodes downstream, acting as an intermediary between clock nodes and client nodes.

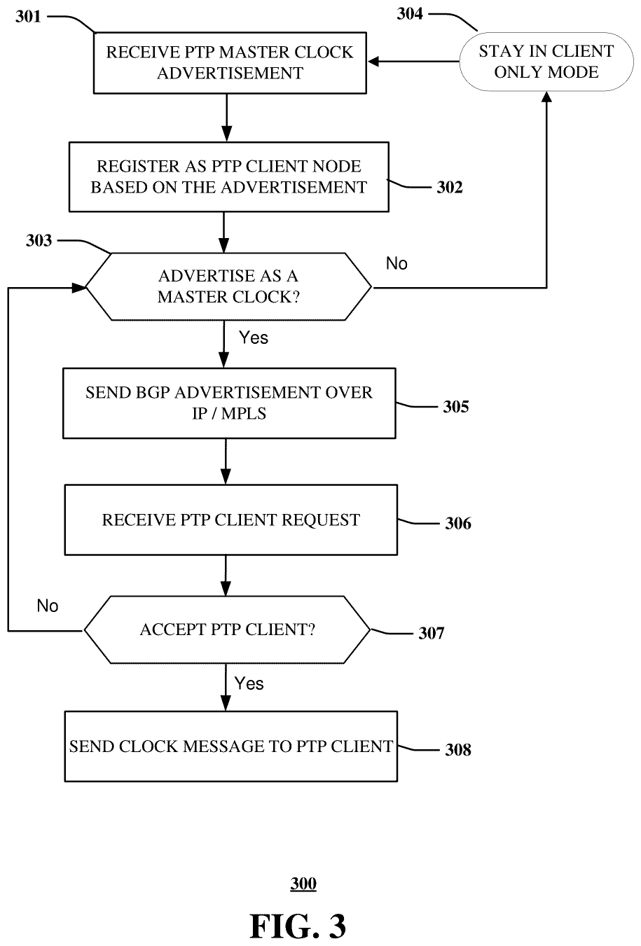

FIG. 3 depicts an illustrative embodiment of a method performed by a node in an IP network in accordance with various aspects described herein. As shown in FIG. 3, method 300 begins at step 301 where a node in an IP/MPLS network receives information sent via BGP about a node advertising its ability to provide PTP master clock service to any clients. Next in step 302, the node sends a message to the PTP master clock node indicating that the node wishes to register as a PTP client based on the information received. The node, having been accepted by the PTP master clock node as a client, receives clock messages from the PTP master clock node, and can synchronize its clock using the messages if the PTP master clock node is selected as the best master clock under BMCA. Next, in step 303, the node determines whether it will advertise itself as a PTP master clock node. If not, then in step 304, the node stays in a client only mode, and the process repeats at step 301.

But if so, then the process continues at step 305, where the node sends out a BGP advertisement over an IP/MPLS network indicating capability as a PTP master clock node. Next in step 306, the node receives a signaling request from a potential PTP client node seeking to become a PTP client. In step 307, the PTP master clock node considers whether to accept the potential PTP client node as a client. The PTP master clock node decides to accept client connections based upon the negotiated parameters that are received via the signaling request. If not, then the process repeats again at step 303. But if so, then in step 308 the node sends clock messages to the newly accepted PTP client node.

While for purposes of simplicity of explanation, the respective processes are shown and described as a series of blocks in FIG. 3, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

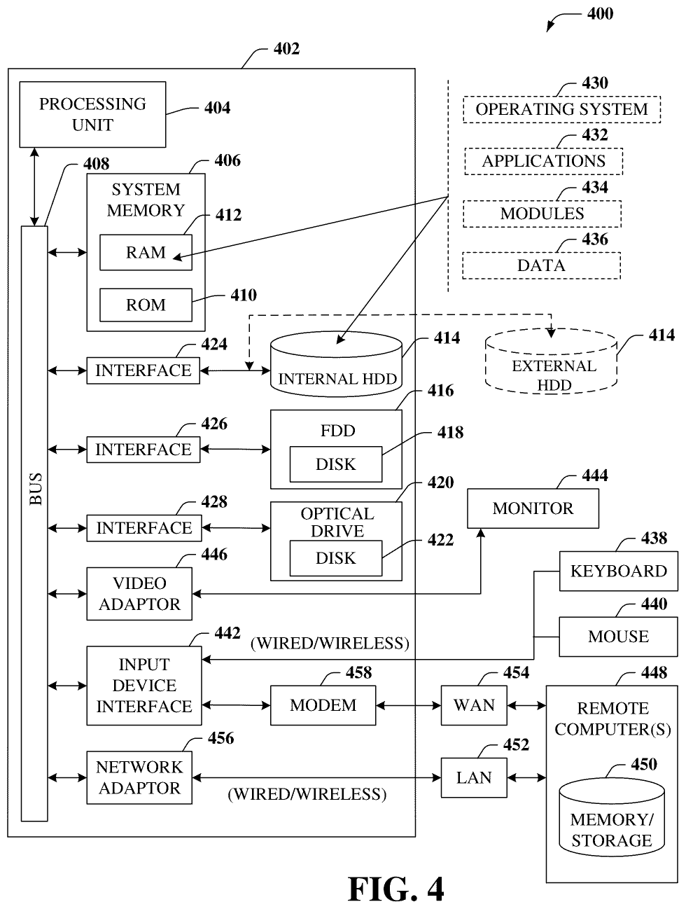

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a computing environment 400, that, when combined with specific equipment such as a GNSS receiver, a timing subsystem including PLL, a forwarding switch/ASIC for Ethernet or IP/MPLS processing capability to support PTP, etc., would be suitable for implementing the various embodiments of the subject disclosure. For example, computing environment 400 can facilitate in whole or in part sending advertisements identifying PTP master clocks in an IP network; registering PTP client nodes through a unicast signaling mechanism; and sending clock messages to PTP client nodes, etc.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory”herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. System memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise high-speed RAM such as static RAM for caching data.

The computer 402 further comprises an internal hard disk drive (HDD 414) (e.g., EIDE, SATA), which internal HDD 414 can also be configured for external use in a suitable chassis (not shown), a magnetic floppy disk drive (FDD 416), (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen and the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can also be connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN 452) and/or larger networks, e.g., a wide area network (WAN 454). Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. Modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are examples and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data. Computer-readable storage media can comprise the widest variety of storage media including tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor;
a clock; and
a memory that stores executable instructions that, when executed by the processing system, facilitate performance of operations, the operations comprising:
advertising via Border Gateway Protocol (BGP) a capability as a precision timing protocol (PTP) master clock through an Internet Protocol (IP)/Multi-Protocol Label Switching (MPLS) network, wherein the advertising includes an IP address of the device;
receiving a unicast signaling mechanism from a node in the network; and
sending clock messages to the node responsive to accepting the node as a PTP client node.

2. The device of claim 1, wherein the device further comprises a receiver configured to receive time information from a time source and wherein the operations further comprise synchronizing the clock to the time source.

3. The device of claim 2, wherein the receiver comprises a Global Navigation Satellite Service (GNSS) receiver.

4. The device of claim 1, wherein the advertising is performed within an Autonomous System (AS) via an interior Border Gateway Protocol (iBGP).

5. The device of claim 1, wherein the advertising is performed between Autonomous Systems (AS) via an exterior Border Gateway Protocol (eBGP).

6. The device of claim 1, wherein the device is on a border between two or more Autonomous Systems (AS).

7. A method, comprising:
receiving, by a precision timing protocol (PTP) client node in an Internet Protocol (IP)/Multi-Protocol Label Switching (MPLS) network, a Border Gateway Protocol (BGP) message indicating a master clock capability of a PTP master clock node;
sending, by the PTP client node, a unicast signaling request to the PTP master clock node to register as a PTP client; and
receiving, by the PTP client node, clock messages from the PTP master clock node responsive to the unicast signaling request.

8. The method of claim 7, wherein the BGP message includes an IP address of the PTP master clock node.

9. The method of claim 7, further comprising synchronizing, by the PTP client node, a clock based on the clock messages received from the PTP master clock node.

10. The method of claim 7, wherein the BGP message is sent within an Autonomous System (AS) via an interior Border Gateway Protocol (iBGP).

11. The method of claim 7, wherein the BGP message is sent between Autonomous Systems (AS) via an exterior Border Gateway Protocol (eBGP).

12. The method of claim 7, further comprising advertising, by the PTP client node, a capability as a PTP master clock via BGP.

13. The method of claim 12, wherein the PTP client node is on a border between two or more Autonomous Systems (AS).

14. The method of claim 13, wherein the advertising is performed within an Autonomous System (AS) via an Interior Border Gateway Protocol (iBGP).

15. The method of claim 13, wherein the advertising is performed between Autonomous Systems (AS) via an exterior Border Gateway Protocol (eBGP).

16. The method of claim 10, further comprising receiving, by the PTP client node, a request from a second node to become a PTP client node.

17. The method of claim 16, further comprising accepting, by the PTP client node, the second node as a PTP client.

18. The method of claim 17, further comprising sending, by the PTP client node, clock messages to the second node responsive to accepting.

19. A non-transitory, machine-readable medium, storing executable instructions that, when executed by a processing system including a processor, facilitate performance of operations, the operations comprising:
identifying a first precision timing protocol (PTP) master clock from a Border Gateway Protocol (BGP) message received over an Internet Protocol (IP)/Multi-Protocol Label Switching (MPLS) network;
registering as a first PTP client node with the first PTP master clock;
synchronizing a clock with first clock messages received from the first PTP master clock;
advertising a capability as a second PTP master clock through the IP/MPLS network;
receiving a request from a second node in the IP/MPLS network to become a second PTP client node; and
sending second clock messages to the second PTP client node responsive to accepting the second PTP client node.

20. The non-transitory, machine-readable medium of claim 19, wherein the advertising is performed via an interior Border Gateway Protocol (iBGP).
